(19) United States
(12) Patent Application Publication
(10) Pub. No.: US 2025/0308412 A1
(43) Pub. Date: Oct. 2, 2025

(54) Midair Warning Device for Ground Level Hazards

(71) Applicant: David Reid, Winchester, CA (US)

(72) Inventor: David Reid, Winchester, CA (US)

(21) Appl. No.: 18/622,859

(22) Filed: Mar. 29, 2024

(51) Int. Cl. G09F 7/18

(52) U.S. Cl. CPC G09F 7/18; G09F 2007/186

(57) ABSTRACT

A midair warning device for warning a man lift operator of a hazard below. The midair warning device includes an attachment base adapted to be attached to a part of a building near a hazard to the man lift operator. The midair warning device includes a warning indicator connected to the attachment base so that the warning indicator is visible to the man lift operator near eye level of the man lift operator.

### BACKGROUND

The present invention generally relates to hazard warning devices. More specifically, the present invention relates a midair warning device to warn users on a movable lift platform of hazards on the ground.

There are no safety items available that hook or attached to a ceiling of buildings under construction to alert man lift operators of hazards below them. The man lift operator could drive the man lift over/into a hazard below eye level of the man lift operator and cause an accident. Hazards can include changes in elevation, rebar, drains, and holes cut in the concrete, etc. that could cause the man lift to tip over.

It is an object of the present invention to provide a device for placement of a warning in midair near a hazard on the ground so a user of a lift platform does not collide with the hazard.

### SUMMARY

A midair warning device for warning a man lift operator of a hazard below. The midair warning device includes an attachment base adapted to be attached to a part of a building near a hazard to the man lift operator. The midair warning device includes a warning indicator connected to the attachment base so that the warning indicator is visible to the man lift operator near eye level of the man lift operator.

### BRIEF DESCRIPTION OF DRAWINGS

FIG. 1 is a perspective front view of a midair warning device according to the present invention.

FIG. 2 is a schematic view of the use of a midair warning device according to the present invention.

FIG. 3 is a perspective rear view and side view of a midair warning device according to the present invention.

FIG. 4 is a perspective front view two midair warning devices according to the present invention.

FIG. 5 is a perspective rear view and side view of a midair warning device according to the present invention.

FIG. 6 is a schematic view of the use of a set up unit for a midair warning device according to the present invention.

FIG. 7 is a schematic view of ground based embodiment of a midair warning device according to the present invention.

### DETAILED DESCRIPTION

The midair warning device acts like a traffic cone would. Instead of being on the ground to alert drivers of a hazard, the midair warning devices are hanging from the ceiling of a building under construction to alert Man Lift operators of a hazard on the ground, so they do not tip the man lift over. The midair warning devices are at the man lift operators eye level, so the operator knows to look down to see that there is a hazard of some sort below him.

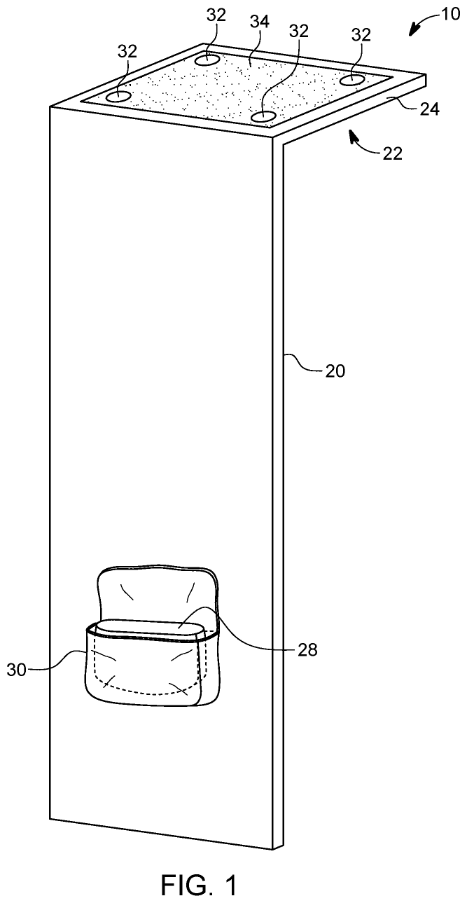

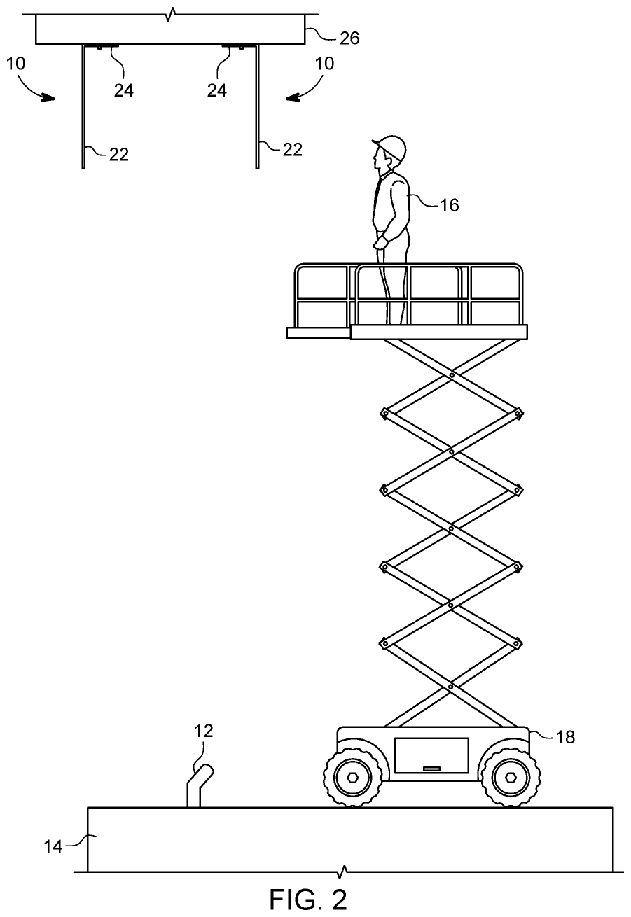

FIGS. 1-2 show a first embodiment of a midair warning device 10. The midair warning device 10 is placed above a hazard 12 on the ground 14 that a user 16 of a movable lift platform 18 wishes to avoid. Preferably, the midair warning device 10 is placed in a position before the user 16 would reach the hazard 12, so the user 16 sees the midair warning device 10 and stops before the hazard 12. FIG. 1 shows the midair warning device 10 includes a warning indicator 20 and an attachment base 22. The attachment base 22 is shown as a mounting flange 24. The mounting flange 24 is mounted at an angle to the warning indicator 20 so that the mounting flange 24 can be mounted to a ceiling 26 and the warning indicator 20 hangs downward from the ceiling 26. The warning indicator 20 for example can be of a 1/62 to 1/32 inch strip of flexible nylon. The size of the warning indicator 20 is shown as approximately four inches wide by two feet long. The warning indicator 20 should be of a weight that provides some wind resistant, so the warning indicator 20 is always hanging downward to be seen by user 16 of the lift platform 18. The warning indicator 20 can include a weight 28 in a Velcro pocket 30 for wind resistance by pulling the warning indicator 20 downward. The warning indicator 20 can also be a strip of material made of a hard plastic or rubber. The warning indicator 20 is of a safety color such as orange to grab the attention of the user 16 of the lift platform 18 before reaching the hazard 12. The mounting flange 24 includes eyelets 32 for using a fastener such as a screw or nail to mount the midair warning device 10 to a surface. The mounting flange 24 can also include an adhesive 34 to attach the mounting flange 24 to a surface. The preferable angle between the mounting flange 24 and the warning indicator 20 is such that the warning indicator 20 is ninety degrees to the ground surface that the lift platform 18 is moving along. FIG. 2 shows two midair warning devices 10 in use. FIG. 2 shows the hazard 12 on the ground 14 at ground level and the user 16 on a lift platform 18 that moves along the ground 14. There are two midair warning devices 10 mounted to the ceiling 26 above, with one midair warning device 10 on each side of the hazard 12. This way, when moving along the ground 14 from either direction of the hazard 12, the user 16 on a lift platform 18 can be warned by the warning indicator 20.

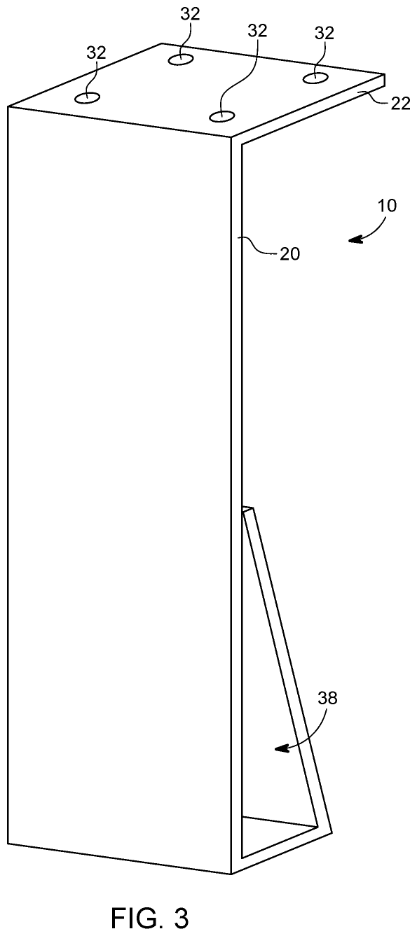

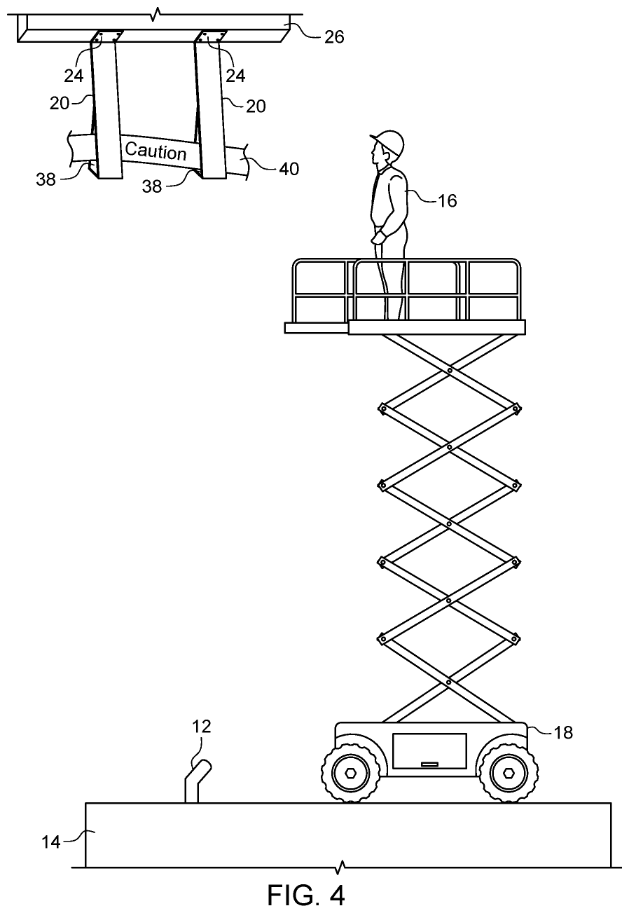

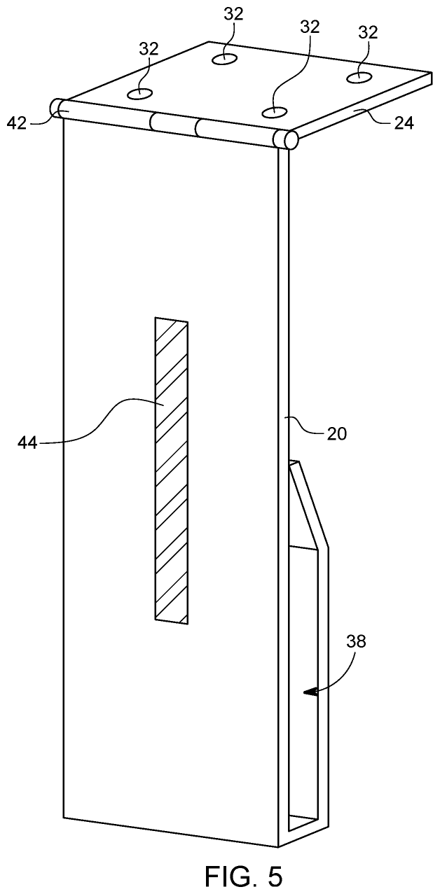

FIGS. 3-4 show a second embodiment of the midair warning device 10. FIG. 3 shows a loop 38 forming an opening as part of the warning indicator 10. The loop 38 is for receiving caution tape 40 strung between two warning indicators 10, as shown in FIG. 4. FIG. 5 shows a third embodiment of the midair warning device 10. FIG. 5 shows a hinge 42 between the warning indicator 20 and the mounting flange 22. Also shown that can be applied to all embodiments of the midair warning device 10 is a reflector 44 and the loop 38.

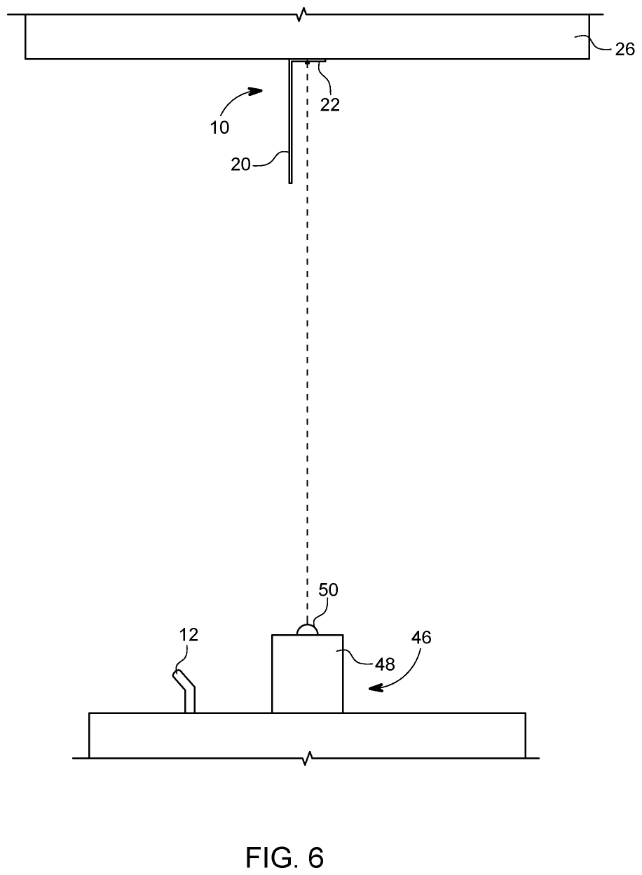

FIG. 6 shows a setup unit 46 for the midair warning device 10. The setup unit 46 includes a base 48 and a light 50 positioned near a rebar hazard 12. The light 50 preferably is a laser light to pinpoint the positon to attach the mounting flange 22 to the ceiling 26. The base 48 is positioned near the hazard 22 with the light 50 reflecting on the ceiling 26. The point where the laser light hits the ceiling 26 is used to position the mounting flange 22.

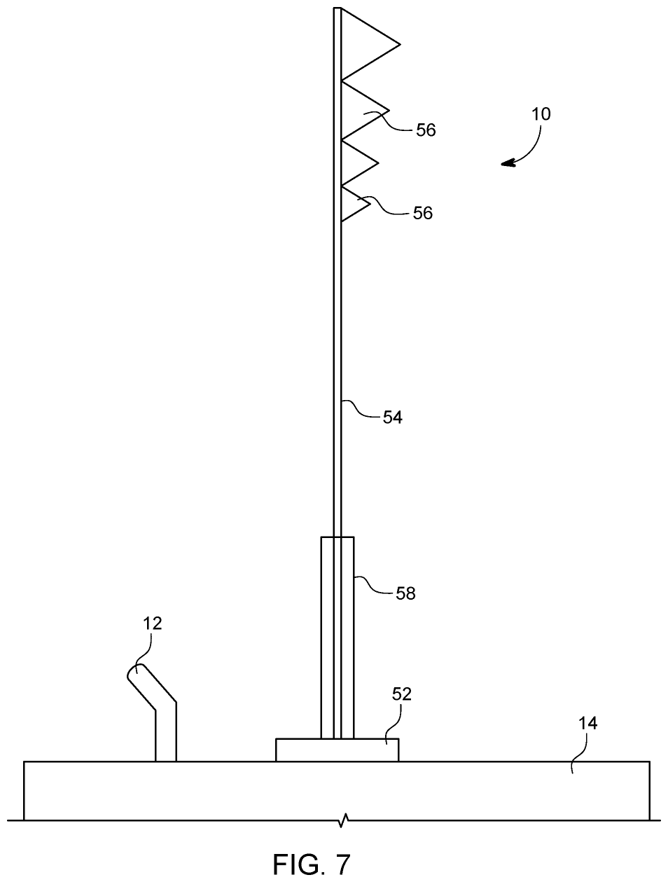

FIG. 7 shows a ground based embodiment of the midair warning device 10. The ground based embodiment includes an attachment base 52, pole 54 and one or more flags 56. The base 54 is positioned on the ground 14 near the hazard 12. The base 50 includes a cylinder tube 58 extending upward from the base 50. The tube 58 is long enough to allow insertion of the pole 54 into the tube 58 so that the tube 58 holds the pole 54 in a vertical position. The pole 54 can be wood, metal or fiberglass, though wood and fiberglass are safer materials when working near electrical devices. Same goes for material choices of the base 50. There is at least one flag 56 attached to the pole 54. The flags 56 are at a height that will be noticed by the user 16 of the lift platform 18 and are of a safety color that is appropriate as a warning, such as orange.

In most cases, there will be four midair warning devices per hazard. If there is hazard against a wall or in a corner, two or three midair warning devices may suffice, but most likely, one midair warning device at each corner around a hazard, thereby boxing in the hazard. The midair warning devices at the four corners can be linked by the warning tape or the midair warning devices can simply hang at the four corners, or have them spaced 2′-3′ apart. Although the midair warning device has been described as a device to warn man lift operators of a terrestrial hazard, it can also be used to warn of hanging hazards as well. Such as a 3′×3′ air vent hanging down 2″ or 3′ from a ceiling. Midair warning devices can be hung around a skyborn hazard as well.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A midair warning device, for warning a man lift operator of a hazard below, comprising:
an attachment base adapted to be attached to a part of a building near a hazard to the man lift operator;
a warning indicator connected to said attachment base so that said warning indicator is visible to the man lift operator near eye level of the man lift operator.

2. The midair warning device of claim 1, wherein said attachment base is adapted to be attached to a part of the building above the eye level of the man lift operator.

3. The midair warning device of claim 2, wherein said attachment base is a flange with eyelets, said eyelets adapted for inserting a fastener for attachment of said flange to the building.

4. The midair warning device of claim 2, wherein said warning indicator is a flexible material and hangs down from said flange.

5. The midair warning device of claim 2, wherein said warning indicator is a ridged material and extends down from said flange.

6. The midair warning device of claim 2, wherein a hinge connects said warning indicator to said attachment base.

7. The midair warning device of claim 2, wherein said warning indicator includes a reflector.

8. The midair warning device of claim 2, wherein said attachment base is a flange with an adhesive layer, said adhesive layer adapted for attachment of said flange to the building.

9. The midair warning device of claim 1, further including a set up unit for positioning said midair warning device, said setup unit including a base and a light, said base adapted to be positioned near a hazard and said light adapted to shine upward for positioning of aid attachment base of said midair warning device.

10. The midair warning device of claim 9, wherein said light is a laser adapted to pinpoint the positon to attach the mounting flange above.

11. The midair warning device of claim 1, wherein said attachment base is adapted to be attached on ground level, wherein said warning indicator includes a pole extending upward from said attachment base, wherein said warning indicator includes at least one flag attached to said pole such that said flag is visible to the man lift operator near eye level of the man lift operator.

12. The midair warning device of claim 11, wherein there is a plurality of said flags attached to said pole such that said flags are visible to the man lift operator near eye level of the man lift operator.

13. The midair warning device of claim 11, wherein attachment base includes a cylinder tube extending upward from said attachment base, said tube long enough to allow insertion of said pole into said tube so that said tube holds said pole a vertical position.
